(19) United States
(12) Patent Application Publication
(10) Pub. No.: US 2025/0086242 A1
(43) Pub. Date: Mar. 13, 2025

(54) METHOD TO IDENTIFY KNOWN SOCIAL MEDIA PRESENCE USING ARTIFICIAL INTELLIGENCE

(71) Applicant: Ahmad L.D. Glover, Hampton, VA (US)

(72) Inventor: Ahmad L.D. Glover, Hampton, VA (US)

(21) Appl. No.: 18/244,717

(22) Filed: Sep. 11, 2023

(51) Int. Cl. G06F 16/9536; G06F 16/907; G06Q 50/00; G06V 40/16

(52) U.S. Cl. CPC G06F 16/9536; G06F 16/907; G06F 16/908; G06Q 50/01; G06V 40/172

(57) ABSTRACT

A method including generating an input interface on a user device configured to input an image comprising a human face into the user device; inputting the image comprising the face into the user device; identifying the face within the image; forming a digital representations of the identified face suitable for electronic searching according to predetermined criteria using one or more processors; searching one or more social media databases for the digital representation of the face within the one or more social media databases; identifying the digital representation of the face within the one or more social media databases; identifying a person associated with the digital representation of the face; retrieving information from the one or more social media databases associated with the identified person; and generating an output user interface comprising at least a portion of the retrieved information on the user device.

### FIELD

The specification relates to a system and method for identifying a person's social media presence based on an image of the person.

### BACKGROUND

The ubiquity of social media allows for greater interaction than previously possible. The growth of the meta-verse and the ability to connect and find people online is becoming more and more of a daily reality. At the same time the meta-verse has grown, social media, facial recognition and artificial intelligence have also grown at an equal or much faster pace. However, there exists no ability to utilize these technologies to meet and connect with people encountered in the real world or in the metaverse outside of social media platforms.

### SUMMARY

In embodiments, a method comprises generating an input interface on a user device configured to input an image comprising a human face into the user device; inputting the image comprising the human face into the user device; identifying the human face within the image comprising the human face; forming a digital representations of the identified human face suitable for electronic searching according to predetermined criteria using one or more processors; searching one or more social media databases for the digital representation of the human face within the one or more social media databases; identifying the digital representation of the human face within the one or more social media databases; identifying a person associated with the digital representation of the human face; retrieving information from the one or more social media databases associated with the identified person; and generating an output user interface comprising at least a portion of the retrieved information on the user device.

In embodiments, a system comprises one or more processors configured to generate an input interface on a user device configured to input an image comprising a human face into the user device; input the image comprising the human face into the user device; identify the human face within the image comprising the human face; form a digital representations of the identified human face suitable for electronic searching according to predetermined criteria using one or more processors; search one or more social media databases for the digital representation of the human face within the one or more social media databases; identify the digital representation of the human face within the one or more social media databases; identify a person associated with the digital representation of the human face; retrieve information from the one or more social media databases associated with the identified person; and generate an output user interface comprising at least a portion of the retrieved information on the user device.

### BRIEF DESCRIPTION OF THE DRAWINGS

The invention is illustrated by way of example, and not by way of limitation in the figures of the accompanying drawings in which like reference numerals are used to refer to similar elements.

FIG. 1 is a flowchart showing a method according to embodiments disclosed herein.

### DETAILED DESCRIPTION

With the growth of the meta-verse, the ability to see connect and find people online is becoming more and more of a daily reality. At the same time the meta-verse has grown, social media, facial recognition and artificial intelligence have also grown at an equal or much faster pace. The inventor has discovered a method, which may be in the form of an app or other program, configured to combine facial recognition with various forms of artificial intelligence, which expands the use of social media and network technology to facilitate the connecting of people in both the metaverse and the real world. In short, a user may simply scan or take a picture and via utilization of the method according to embodiments disclosed herein, find their social online presence of the target person or persons in a few clicks. From there, the app facilitates the end user to connect, interact, follow or simply view social media content of the target person.

In the following description, for purposes of explanation, numerous specific details are set forth in order to provide a thorough understanding of the invention. It will be apparent, however, to one skilled in the art that the embodiments can be practiced without these specific details. In other instances, structures and devices are shown in block diagram form in order to avoid obscuring the invention. For example, the invention is described in one embodiment below with reference to user devices such as a smart phone and particular software and hardware. However, the description applies to any type of computing device that can receive data and commands, and any peripheral devices providing services.

Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

Some embodiments can take the form of an entirely hardware embodiment, an entirely software embodiment or an embodiment containing both hardware and software elements. A preferred embodiment is implemented in software, which includes but is not limited to firmware, resident software, microcode, etc.

Furthermore, some embodiments can take the form of a computer program product accessible from a computer-usable or computer-readable medium providing program code for use by or in connection with a computer or any instruction execution system. For the purposes of this invention, a computer-usable or computer readable medium can be any apparatus that can contain, store, communicate, propagate, or transport the program for use by or in connection with the instruction execution system, apparatus, or device.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the specification is not described with reference to any particular programming language. It will be appreciated that a variety of programming languages may be used to implement the teachings of the various embodiments as described herein.

In embodiments, a method comprises generating an input interface on a user device configured to input an image comprising a human face into the user device; inputting the image comprising the human face into the user device; identifying the human face within the image comprising the human face; forming a digital representations of the identified human face suitable for electronic searching according to predetermined criteria using one or more processors; searching one or more social media databases for the digital representation of the human face within the one or more social media databases; identifying the digital representation of the human face within the one or more social media databases; identifying a person associated with the digital representation of the human face; retrieving information from the one or more social media databases associated with the identified person; and generating an output user interface comprising at least a portion of the retrieved information on the user device.

In embodiments, the identifying the digital representation of the human face within the one or more social media databases comprises searching one or more visual databases for the digital representation of the human face; obtaining one or more labels associated with the digital representation of the identified human face from the one or more visual databases; and searching the one or more social media databases based at least in part on the one or more labels.

In embodiments, the image comprising the human face is obtained directly from the user device. In embodiments, the image comprising the human face is a virtual avatar. In embodiments, the image comprising the human face input into the user device further comprises metadata; wherein the digital representations of the identified human face further comprises at least a portion of the metadata; wherein the searching one or more social media databases for the digital representation of the human face within the one or more social media databases is based in part on at least a portion of the metadata; wherein the identifying the digital representation of the human face within the one or more social media databases is based in part on at least a portion of the metadata; and wherein the identifying a person associated with the digital representation of the human face is based in part on at least a portion of the metadata.

In embodiments, the input interface is further configured for input of one or more labels by the user associated with the image comprising the human face; wherein the searching one or more social media databases for the digital representation of the human face within the one or more social media databases is based in part on the one or more labels input by the user; and wherein the identifying the digital representation of the human face within the one or more social media databases is based in part on the one or more labels input by the user.

In embodiments, the one or more labels input by the user comprise at least a portion of a name, a location, an activity, and/or an employer of a person having the human face present in the image comprising the human face.

In embodiments, the method further comprises identifying one or more labels present within the image comprising the human face; wherein the input interface is further configured for input of the one or more labels identified in the image comprising the human face; wherein the searching one or more social media databases for the digital representation of the human face within the one or more social media databases is based in part on the one or more labels identified in the image comprising the human face; and wherein the identifying the digital representation of the human face within the one or more social media databases is based in part on the one or more labels identified in the image comprising the human face. In embodiments, the one or more labels identified within the image comprising the human face comprise at least a portion of a name, a location, an activity, and/or an employer of a person having the human face present in the image comprising the human face.

In embodiments, the output user interface is configured to provide the user with an option to perform at least one of communicating via social media with the identified person, submitting a social media communication request to the identified person; submitting a social media comment to the identified person via social media; or a combination thereof.

In embodiments, the output user interface further comprises at least one of an image of the identified person, a link to a social media feed associated with the identified person; a mechanism to enable the user to input a comment to a social media feed associated with the identified person; contact information associated with the identified person; or a combination thereof.

In embodiments, a system comprises one or more processors configured to generate an input interface on a user device configured to input an image comprising a human face into the user device; input the image comprising the human face into the user device; identify the human face within the image comprising the human face; form a digital representations of the identified human face suitable for electronic searching according to predetermined criteria using one or more processors; search one or more social media databases for the digital representation of the human face within the one or more social media databases; identify the digital representation of the human face within the one or more social media databases; identify a person associated with the digital representation of the human face; retrieve information from the one or more social media databases associated with the identified person; and generate an output user interface comprising at least a portion of the retrieved information on the user device.

In embodiments, the system is further configured to identify the digital representation of the human face within the one or more social media databases comprising searching one or more visual databases for the digital representation of the human face; obtaining one or more labels associated with the digital representation of the identified human face from the one or more visual databases; and searching the one or more social media databases based at least in part on the one or more labels.

In embodiments, the system is further configured to input the image comprising the human face obtained directly from the user device.

In embodiments, the image comprising the human face is a virtual avatar. In embodiments, the image comprising the human face input into the user device further comprises metadata; wherein the digital representations of the identified human face further comprises at least a portion of the metadata; wherein the searching one or more social media databases for the digital representation of the human face within the one or more social media databases is based in part on at least a portion of the metadata; wherein the identifying the digital representation of the human face within the one or more social media databases is based in part on at least a portion of the metadata; and wherein the identifying a person associated with the digital representation of the human face is based in part on at least a portion of the metadata.

In embodiments, the system is further configured for input of one or more labels by the user associated with the image comprising the human face; wherein the searching one or more social media databases for the digital representation of the human face within the one or more social media databases is based in part on the one or more labels input by the user; and wherein the identifying the digital representation of the human face within the one or more social media databases is based in part on the one or more labels input by the user.

In embodiments, the system is further configured to identify one or more labels present within the image comprising the human face; wherein the input interface is further configured for input of the one or more labels identified in the image comprising the human face; wherein the searching one or more social media databases for the digital representation of the human face within the one or more social media databases is based in part on the one or more labels identified in the image comprising the human face; and wherein the identifying the digital representation of the human face within the one or more social media databases is based in part on the one or more labels identified in the image comprising the human face.

In embodiments, one or more labels identified within the image comprising the human face comprise at least a portion of a name, a location, an activity, and/or an employer of a person having the human face present in the image comprising the human face.

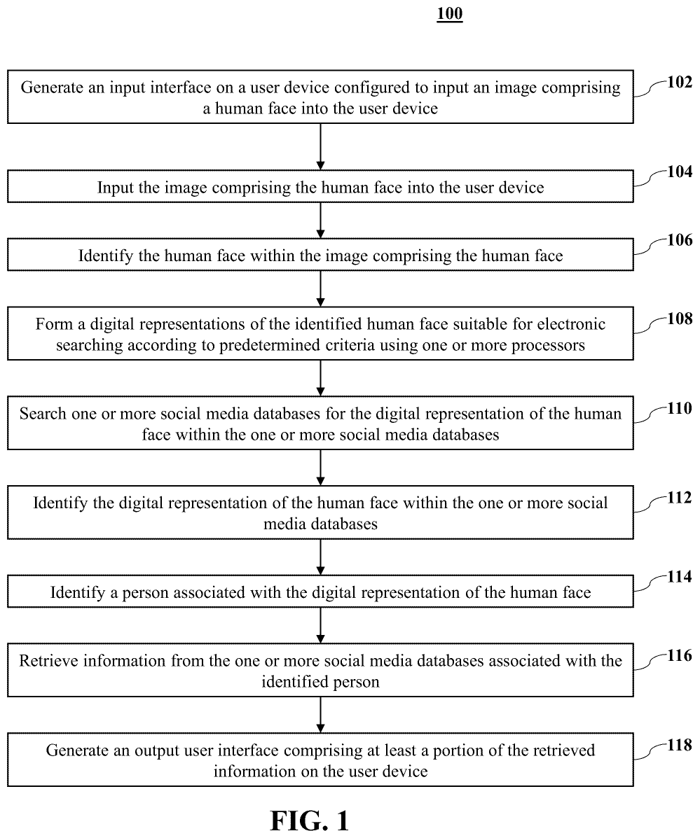

FIG. 1 is a flowchart of an example process 100. In some embodiments, one or more blocks of FIG. 1 may be performed by an end user, and/or a system. As shown in FIG. 1, process 100 may include generating an input interface on an user device configured to input an image having a human face into the user device (block 102). For example, the system may generate an input interface on an user device configured to input an image having a human face into the user device, as described above. As also shown in FIG. 1, process 100 may include inputting the image having the human face into the user device (block 104). For example, the user may input the image having the human face into the user device, as described above, wherein the image is obtained directly from the user device, and/or wherein the image comprising the human face is a virtual avatar.

As further shown in FIG. 1, process 100 may include identifying the human face within the image having the human face (block 106). For example, System may identify the human face within the image having the human face, as described above. In embodiments, the identifying the digital representation of the human face within the one or more social media databases may comprise searching one or more visual databases for the digital representation of the human face; obtaining one or more labels associated with the digital representation of the identified human face from the one or more visual databases; and searching the one or more social media databases based at least in part on the one or more labels.

As also shown in FIG. 1, process 100 may include forming a digital representation of the identified human face suitable for electronic searching according to predetermined criteria using one or more processors (block 108). For example, System may form a digital representations of the identified human face suitable for electronic searching according to predetermined criteria using one or more processors, as described above. As further shown in FIG. 1, process 100 may include searching one or more social media databases for the digital representation of the human face within the one or more social media databases (block 110). For example, System may search one or more social media databases for the digital representation of the human face within the one or more social media databases, as described above. As also shown in FIG. 1, process 100 may include identifying the digital representation of the human face within the one or more social media databases (block 112). For example, System may identify the digital representation of the human face within the one or more social media databases, as described above. As further shown in FIG. 1, process 100 may include identifying a person associated with the digital representation of the human face (block 114). For example, System may identify a person associated with the digital representation of the human face, as described above. As also shown in FIG. 1, process 100 may include retrieving information from the one or more social media databases associated with the identified person (block 116). For example, System may retrieve information from the one or more social media databases associated with the identified person, as described above. As further shown in FIG. 1, process 100 may include generating an output user interface having at least a portion of the retrieved information on the user device (block 118). For example, System may generate an output user interface having at least a portion of the retrieved information on the user device, as described above.

Although FIG. 1 shows example blocks of process 100, in some implementations, process 100 may include additional blocks, fewer blocks, different blocks, or differently arranged blocks than those depicted in FIG. 1. Additionally, or alternatively, two or more of the blocks of process 100 may be performed in parallel. In addition, any one or more of the blocks may be performed locally by the end user device, remotely via networked platforms, or any combination thereof.

In embodiments, the image comprising the human face input into the user device may be a picture, a photograph, a screenshot, and/or the like. In embodiments, the identifying the human face within the image comprising the human face may include one or more face recognition algorithms, as readily understood in the art. The identifying the human face within the image may include forwarding the image to a remote system wherein the image is analyzed for, and identifies the human face or representation to form a digital representations of the identified human face suitable for electronic searching according to predetermined criteria using one or more processors. In embodiments, the searching of one or more social media databases for the digital representation of the human face within the one or more social media databases may include any number of different databases associated with a social media database, and/or a database configured to identify a human face within feeds or data provided by one or more social media databases.

In embodiments, the identifying the digital representation of the human face within the one or more social media databases comprises searching one or more visual databases for the digital representation of the human face; obtaining one or more labels associated with the digital representation of the identified human face from the one or more visual databases; and searching the one or more social media databases based at least in part on the one or more labels. Suitable labels include data entered by the end user such as a location, employer, group affiliation, and/or the like, and/or may include data obtained from the image comprising the human face, and/or from metadata associated with the image comprising the human face.

In embodiments, the image comprising the human face may be obtained directly from the user device. Examples include a picture or video frame taken by the user device, a webpage or screenshot of the user device, and/or the like. In embodiments, the image comprising the human face is a virtual avatar. Examples include metaverse avatars, and/or the like.

In embodiments, the image comprising the human face input into the user device may further comprise metadata. In some embodiments, the digital representations of the identified human face further comprises at least a portion of the metadata. In such embodiments, the searching one or more social media databases for the digital representation of the human face within the one or more social media databases may be based in part on at least a portion of the metadata. In embodiments, the identifying the digital representation of the human face within the one or more social media databases may be based in part on at least a portion of the metadata. In embodiments, the identifying a person associated with the digital representation of the human face may be based in part on at least a portion of the metadata.

In embodiments, the input interface is further configured for input of one or more labels by the user associated with the image comprising the human face. Suitable labels include any known information about the person being identified (comprising the human face). Examples include dates, timestamps, locations, affiliations, employers, known associates, attended educational institutions, athletic teams followed by the person, activities of the person, and/or the like. In some embodiments, the searching one or more social media databases for the digital representation of the human face within the one or more social media databases may be based in part on the one or more labels input by the user. In embodiments, the identifying the digital representation of the human face within the one or more social media databases may be based in part on the one or more labels input by the user.

In embodiments, the one or more labels input by the user comprise at least a portion of a name, a location, an activity, and/or an employer of a person having the human face present in the image comprising the human face.

In embodiments, one or more labels utilized in the search are identified within the image comprising the human face. For example, an image comprising the human face also includes a sports team logo. This sports team logo may be identified and include in the search. In embodiments, the input interface is further configured for input of the one or more labels identified in the image comprising the human face, either manually, by association with the image e.g., a time and/or geolocation, or identified directly from the image. In embodiments, the searching one or more social media databases for the digital representation of the human face within the one or more social media databases may be based in part on the one or more labels identified in the image comprising the human face. In embodiments, the identifying the digital representation of the human face within the one or more social media databases may be based in part on the one or more labels identified in the image comprising the human face.

In embodiments, the output user interface is configured to provide the user with an option to perform at least one of communicating via social media with the identified person, submitting a social media communication request to the identified person; submitting a social media comment to the identified person via social media; or a combination thereof. Examples include sending a friends request, sending a follow request, and/or the like, as commonly understood with regard to social media trends and customs.

In embodiments, the output user interface further comprises at least one of an image of the identified person, a link to a social media feed associated with the identified person; a mechanism to enable the user to input a comment to a social media feed associated with the identified person; contact information associated with the identified person; or a combination thereof.

In embodiments, a system is configured to complete any one or combinations of the methods according to the embodiments disclosed herein. In embodiments, the system comprises one or more processors configured to generate an input interface on a user device configured to input an image comprising a human face into the user device. Examples of user devices include smart phones, computers, tablets, and/or any such computing device. In embodiments, the system is configured to receive the input image comprising the human face into the user device. In embodiments, the system includes a plurality of networked and/or otherwise associated computing devices and/or processors configured to identify the human face within the image comprising the human face; form a digital representations of the identified human face suitable for electronic searching according to predetermined criteria using one or more processors; search one or more social media databases for the digital representation of the human face within the one or more social media databases; identify the digital representation of the human face within the one or more social media databases; identify a person associated with the digital representation of the human face; retrieve information from the one or more social media databases associated with the identified person; and generate the output user interface comprising at least a portion of the retrieved information on the user device.

In embodiments, the system includes at least one user device accessed by the user, and may further include a mixed media reality (MMR) server, a content management server, a social network server, and/or the like, communicatively coupled to a network. Persons of ordinary skill in the art will recognize that the engines and storage in one server could also be combined with another server.

In embodiments, the network is a conventional type, wired or wireless, and may have any number of configurations such as a star configuration, token ring configuration or other configurations known to those skilled in the art. Furthermore, the network may comprise a local area network (LAN), a wide area network (WAN) (e.g., the Internet), and/or any other interconnected data path across which multiple devices may communicate. In yet another embodiment, the network may be a peer-to-peer network. The network may also be coupled to or includes portions of a telecommunications network for sending data in a variety of different communication protocols. In yet another embodiment, the network includes Bluetooth communication networks or a cellular communications network for sending and receiving data such as via short messaging service (SMS), multimedia messaging service (MMS), hypertext transfer protocol (HTTP), direct data connection, WAP, email, etc. In embodiments, any number of networks can be connected to various entities of the system.

In embodiments, the user device is any computing device that includes an access module, a memory and a processor, adapted to send and receive information such as images, time, location, etc. The user device is connected to the network via signal line and is configured to allow the user to interact with the user device the via signal line.

The access module includes software for capturing an image and transmitting the image to one or more parts of the system, e.g., an MMR server for performing a visual search. The system is further configured such that once the MMR server transmits the MMR object to the social network server, the social network server generates a user interface, the user interface is transmitted to the access module for display on the user device. In embodiments, the access module or “app” is a self-contained application for performing one or more of the various method steps. In another embodiment, the access module works in conjunction with a browser to capture the image and display the user interface.

The social network server includes a social network application and storage. A social network is any type of social structure where the users are connected by a common feature. The common feature includes, work, school, friendship, family, an interest, etc. The searching of the social network may include discussion threads, conversations related to the received information, data storage associated with the social network such as user information, relationships between users as a social graph, discussion threads, conversations between users, and the like. One or more social network servers are coupled to the network via one or more signal lines.

In embodiments, the system may comprise, or interact with a content management server including a content management engine and a metadata database. The content management server may be coupled with the network via a signal line.

The metadata database may be configured to store and index metadata associated with various objects stored in one or more of the associated databases. The metadata is any data that provides information about one or more aspects of the digital representation of the human face. For example, the metadata may include information obtained from the image. In embodiments, the metadata is automatically populated in an offline process. In embodiments, the metadata database is updated after receiving metadata from the social network server about a user or other interaction such as comments, links, PDFs, chats, user connections, and the like.

In embodiments, any one or more of the blocks of the method, and/or any one or more of the various subparts may utilize, learn from, and/or be conducted at least in part via artificial intelligence including reactive algorithms, limited memory algorithms, theory of mind algorithms, and/or so-called “self-awareness” algorithms.

In embodiments, one or more machine learning and/or artificial intelligence algorithms are employed to best optimize the generating an input interface on a user device configured to input an image comprising a human face into the user device, and/or the inputting the image comprising the human face into the user device, and/or the identifying the human face within the image comprising the human face, and/or the forming a digital representations of the identified human face suitable for electronic searching according to predetermined criteria using one or more processors, and/or the searching one or more social media databases for the digital representation of the human face within the one or more social media databases, and/or the identifying the digital representation of the human face within the one or more social media databases, and/or the identifying a person associated with the digital representation of the human face, and/or the retrieving information from the one or more social media databases associated with the identified person, and/or the generating an output user interface comprising at least a portion of the retrieved information on the user device. In embodiments, the wireless charging system may utilize one or more classification algorithms, e.g., Naive Bayes, decision tree, random forest, support vector machines; K nearest neighbors, and the like; and/or one or more regression algorithms, e.g., linear regression; lasso regression; logistic regression, multivariate regression, multiple regression; and the like.

In some embodiments, the wireless charging system utilizes one or more clustering algorithms, which may include K-Means clustering, fuzzy C-means algorithms, expectation-maximization algorithms, hierarchical clustering algorithms, and/or the like.

In embodiments, the system is further configured to allow various users and persons identified in such searches to prevent the searcher from obtaining any information about them, or to limit the information available for display by such a search. In embodiments, the system is further configured according to various predetermined values to allow, and/or to prevent retrieval and/or display of information based on an age of the person having the human face identified in the image. In addition, the system may further be configured to provide information resulting from such a search, which would not otherwise be provided or generally available, including contact information and/or the like.

The foregoing description of the embodiments has been presented for the purposes of illustration and description. It is not intended to be exhaustive or to limit the specification to the precise form disclosed. Many modifications and variations are possible in light of the above teaching. It is intended that the scope of the embodiments be limited not by this detailed description, but rather by the claims of this application. As will be understood by those familiar with the art, the examples may be embodied in other specific forms without departing from the spirit or essential characteristics thereof. Likewise, the particular naming and division of the modules, routines, features, attributes, methodologies and other aspects are not mandatory or significant, and the mechanisms that implement the description or its features may have different names, divisions and/or formats. Furthermore, as will be apparent to one of ordinary skill in the relevant art, the modules, routines, features, attributes, methodologies and other aspects of the specification can be implemented as software, hardware, firmware or any combination of the three. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the specification is in no way limited to implementation in any specific programming language, or for any specific operating system or environment. Accordingly, the disclosure is intended to be illustrative, but not limiting, of the scope of the specification, which is set forth in the following claims.

1. A method comprising the steps of:
generating an input interface on a user device configured to:
a) input an image comprising a human face into the user device;
b) electronically identify the human face within the image comprising the human face;
c) form a digital representation of the identified human face suitable for electronic searching according to predetermined criteria using results obtained by searching one or more visual databases for the electronically identified human face;
d) generate a search request comprising one or more labels associated with the digital representation of the identified human face using a Naive Bayes, decision tree, random forest, support vector machine, and/or K nearest neighbor classification algorithm;
e) search one or more social media databases using the search request for the digital representation of the human face within the one or more social media databases to identify possible matches for the digital representation of the human face within the one or more social media databases;
f) retrieve information from the one or more social media databases associated with the possible matches; and
generating an output user interface on the user device comprising a user selectable listing comprising at least a portion of the retrieved information on the user device, wherein the information associated with the possible matches is ordered using a regression algorithm comprising a linear regression; lasso regression; logistic regression, multivariate regression, and/or multiple regression analysis.

2. (canceled)

3. The method of claim 1, wherein the image comprising the human face is obtained directly from the user device.

4. The method of claim 1, wherein the image comprising the human face is a virtual avatar.

5. The method of claim 1, wherein the image comprising the human face input into the user device further comprises metadata;
wherein the search request further comprises the metadata;
and wherein the possible matches for the digital representation of the human face within the one or more social media databases are based in part on at least a portion of the metadata.

6. The method of claim 1, wherein the input interface is further configured for input of one or more labels by the user associated with the image comprising the human face;
wherein the search request further comprises the
one or more labels input by the user; and
and wherein the possible matches for the digital representation of the human face within the one or more social media databases are based in part on the one or more labels input by the user.

7. The method of claim 6, wherein the one or more labels input by the user comprise at least a portion of a name, a location, an activity, and/or an employer of a person having the human face present in the image comprising the human face.

8. The method of claim 1, wherein the input interface on a user device is further configured to generate one or more labels based on non-human face items present within the image comprising the human face;
wherein the search request further comprises the
one or more labels generated from the image comprising the human face;
and wherein the possible matches for the digital representation of the human face within the one or more social media databases are based in part on the one or more labels generated from the image comprising the human face.

9. The method of claim 8, wherein the one or more labels identified within the image comprising the human face comprise at least a portion of a name, a location, an activity, and/or an employer of a person having the human face present in the image comprising the human face.

10. The method of claim 1, wherein the output user interface is configured to provide the user with an option to perform at least one of communicating via social media submitting a social media communication request; submitting a social media comment; or a combination thereof based on the retrieved information from the one or more social media databases associated with the possible matches.

11.-20. (canceled)
